(19) United States
(12) Patent Application Publication
(10) Pub. No.: US 2020/0048466 A1
(43) Pub. Date: Feb. 13, 2020

(54) Cold Patch Asphaltic Binder

(71) Applicant: Billy Shane McDADE, Austin, TX (US)

(72) Inventor: Billy Shane McDADE, Austin, TX (US)

(21) Appl. No.: 16/537,035

(22) Filed: Aug. 9, 2019

Related U.S. Application Data
(60) Provisional application No. 62/717,365, filed on Aug. 10, 2018.

(51) Int. Cl. C08L 95/00; E01C 7/26; E01C 11/00; E01C 7/20

(52) U.S. Cl. CPC C08L 95/00; E01C 7/26; C08L 2555/74; E01C 7/20; E01C 11/005

(57) ABSTRACT

Disclosed are binder formulations that can be configured to reduce or limit the evaporation of volatile solvents of an asphalt concrete within which the binder is used. Some embodiments can relate to an asphalt concrete having an embodiment of the binder. Additional embodiments can involve methods of producing the binder and/or the asphalt concrete.

### CROSS-REFERENCE TO RELATED APPLICATIONS

This patent application is related to and claims the benefit of U.S. Provisional Application No. 62/717,365 filed on Aug. 10, 2018, the entire contents of which are incorporated by reference.

### FIELD OF THE INVENTION

Embodiments of the invention relate to binder formulations for use in asphalt concrete.

### BACKGROUND OF THE INVENTION

Cold Patch is a type of asphalt concrete that is intended to be stockpiled or bagged for a period of time before being used. It is desirable for the Cold Patch to remain workable until it is used, but cure and harden once it is compacted. The ability to remain workable, but then cure and harden upon compaction is generally due to volatile solvents included as part of the binder formulation for the asphalt concrete. Conventional Cold Patch formulations are limited in that the volatile solvent component of the asphalt binder tends to evaporate quickly. This evaporation tends to result in an asphalt concrete that is unworkable before it is used. This can be exacerbated if the asphalt concrete has been stockpiled for a period of time. Applying more volatile solvent to the asphalt concrete may allow it to be more workable, but will result in an asphalt concrete that takes longer to cure, and thus results in material that can be damaged after placement before it is completely cured.

Thus, there is a need for a technical solution to address the above-identified problems.

### SUMMARY OF THE INVENTION

Embodiments can relate to a binder formulation that can be configured to reduce or limit the evaporation of volatile solvents of an asphalt concrete within which the binder is used. Some embodiments can relate to an asphalt concrete having an embodiment of the binder. Additional embodiments can involve methods of producing the binder and/or the asphalt concrete.

In at least one embodiment, a binder additive can include a volatile solvent additive comprising diesel fuel; a base asphalt softener additive comprising maltenes; and a hydrocarbon absorber additive comprising gilsonite, the hydrocarbon absorber additive being configured to absorb at least some volatile hydrocarbon fractions of the volatile solvent additive. In some embodiments, the binder additive is an asphaltic binder additive configured to be combined with base asphalt. In some embodiments, the binder additive is configured to obtain a desired viscosity for the base asphalt/binder additive mixture. In some embodiments, the binder additive comprises any one or combination of naphtha, kerosene, diesel fuel, and gasoline. In some embodiments, the base asphalt softener additive is configured to soften the base asphalt.

In at least one embodiment, an asphalt concrete can include aggregate; and a binder additive comprising base asphalt and at least one additive, the at least one additive configured to volatile hydrocarbon fractions and controllably release the volatile hydrocarbon fractions. In some embodiments, the binder additive can include: a volatile solvent additive comprising diesel fuel; a base asphalt softener additive comprising maltenes; and a hydrocarbon absorber additive comprising gilsonite, the hydrocarbon absorber additive being configured to absorb at least some volatile hydrocarbon fractions of the volatile solvent additive. In some embodiments, the aggregate comprises a first aggregate and a second aggregate. In some embodiments, the binder additive is configured to obtain a desired viscosity for a mixture comprising base asphalt and the binder additive. In some embodiments, the binder additive comprises any one or combination of naphtha, kerosene, diesel fuel, and gasoline.

In some embodiments, the base asphalt softener additive is configured to soften the base asphalt. Some embodiments can include use of additional maltenes additive to generate a high yield asphalt cement. In some embodiments the aggregate comprises any one or combination of sand, gravel, crushed stone, slag, recycled roadway material, limestone, granite, shale, caliche, and Limestone Rock Aggregate (LRA). In some embodiments the asphalt concrete is workable, curable, and able to be hardened after being stockpiled for six months. In some embodiments the asphalt concrete is workable, curable, and able to be hardened after being stockpiled for one year.

In at least one embodiment, a method for preparing and using asphalt concrete can involve: adding a binder to an aggregate to form a mix; allowing the mix to be stockpiled for a time period within a range from one hour to one year; within a temperature range from 20° F. and 120° F., compacting the mix into an asphalt concrete formation; and allowing the asphalt concrete formation to cure and harden. The method can involve generating the binder by combining a binder additive containing diesel fuel, a base asphalt softener additive containing maltenes, and a hydrocarbon absorber additive containing gilsonite, the hydrocarbon absorber additive being configured to absorb at least some volatile hydrocarbon fractions of the volatile solvent additive. The method can involve adding a maltenes additive to generate a high yield asphalt cement.

In at least one embodiment, an asphalt concrete can include a combination of Limestone Rock Aggregate (LRA) and a binder to form a cold patch concrete. In some embodiments, the binder includes diesel fuel. In some embodiments, a weight percent of LRA is within a range from 99% to 95%.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present invention will be more apparent from the following more particular description thereof, presented in conjunction with the following drawings. Like reference numbers used in the drawings may identify like components.

FIG. 1 shows an exemplary flow diagram that can be used for making am embodiment of the asphalt concrete or binder.

FIGS. 2-4 show laboratory test results of samples of a mix that demonstrate acceptable material specification tolerances.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

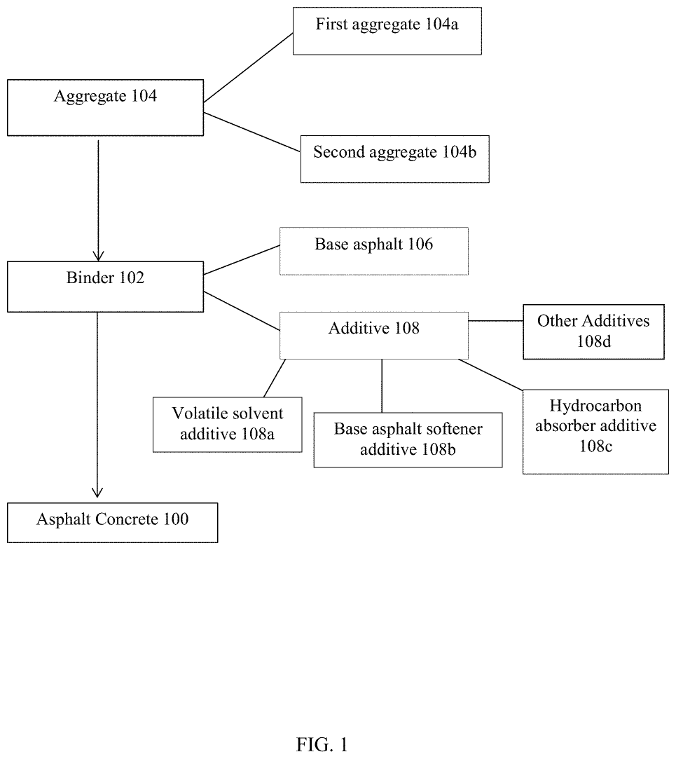

Referring to FIG. 1, embodiments can relate to asphalt concrete 100, a binder 102 for the asphalt concrete 100, and methods of making the same. Some embodiments can relate to formulations of a binder 102 for the asphalt concrete 100. Embodiments of the binder 102 can be formulated to absorb a volatile solvent additive 108a and release it controllably. This can lead to enhanced or more refined material properties of the binder itself (e.g., viscosity) and of the complete concrete mix which includes binder and aggregates (e.g., stability, compressive strength, mix specification tolerances, etc.) and/or improved handling properties (e.g., greater stockpile life, more cost effective, etc.) of the asphalt concrete 100.

Asphalt concrete 100 can be characterized in two general categories: 1) Hot Mix; and 2) Cold Patch. The distinction between the two is mostly related to the application of the asphalt concrete 100. Cold Patch is generally designed to be mixed, stored, and applied at a temperature range that is lower than a temperature range at which Hot Mix is applied. The temperature range for Cold Patch is generally between 20° F. and 120° F. Hot Mix is generally designed to be heated to approximately 350° F. and applied before it cools beyond a certain temperature.

With Cold Patch, a volatile solvent additive 108a (sometimes referred to as a “volatile cutter” or just a “cutter”) is used to keep the base asphalt 106 of the asphalt concrete 100 as a liquid before (e.g., during stockpiling) and during application (e.g., being applied as pavement, a sidewalk, roadway, etc.) of the asphalt concrete 100. With Hot Mix, the heat from the preheat treatment is used keep the base asphalt 106 of the asphalt concrete 100 as a liquid during application of the asphalt concrete 100.

While embodiments of the asphalt concrete 100 and the binder 102 formulations disclosed herein may be described specifically for Cold Patch type asphalt concretes 100, it is contemplated for the binder 102 formulations and other methods disclosed herein to be applicable for any material compound in which a controlled absorption and release of volatile solvent additive 108a is desired.

Embodiments of the asphalt concrete 100 can include an aggregate 104 and a binder 102. The mixture of aggregate 104 and binder 102 can sometimes be referred to as “the mix”. The binder 102 can include base asphalt 106 (sometimes referred to as asphalt) and at least one additive 108.

### Examples of Aggregate

Embodiments of the aggregate 104 can be a particulate matter used as a composite material in the asphalt concrete 100. The aggregate 104 be any one or combination of sand, gravel, crushed stone, slag, recycled roadway material, limestone, granite, shale, caliche, Limestone Rock Aggregate (LRA), etc. LRA is limestone that has been impregnated with bituminous material by a naturally occurring process. The aggregate 104 can be a fine and/or coarse material of particulate matter. The fineness or coarseness of the particulate matter can be measured using an industry gradation convention. The gradation is generally a measure of the particulate size (e.g., a diameter).

The gradation of the aggregate 104 can be within a range from 0.0029 inches (i.e., No. 200 sieve) to 1 inch (i.e., Mesh 1 inch). For example, the aggregate 104 particulate can be No. 200 sieve, No. 170 sieve, No. 140 sieve, No. 120 sieve, No. 100 sieve, No. 80 sieve, No. 70 sieve, No. 60 sieve, No. 50 sieve, No. 45 sieve, No. 40 sieve, No. 35 sieve, No. 25 sieve, No. 20 sieve, No. 18 sieve, No. 16 sieve, No. 14 sieve, No. 12 sieve, No. 10 sieve, No. 20 sieve, No. 8 sieve, No. 7 sieve, No. 6 sieve, No. 5 sieve, No. 4 sieve, No. 3.5 sieve, Mesh 0.25 in., Mesh 0.0.265 in., Mesh 0.3125 in. Mesh 0.375 in., Mesh 0.4375 in., Mesh 0.5 in., Mesh 0.53 in., Mesh 0.625 in., Mesh 0.75 in., Mesh 0.875 in., Mesh 1 in.

Generally, the gradation is a specification required by an end-user (e.g., the Texas Department of Transportation). For example, the gradation of the aggregate 104 may be a certain percentage (e.g., 95% to 99%) being Mesh ⅜ inch with no particulate greater than Mesh 1 inch and less than 5% particulate being less than No. 200 sieve. As noted herein, the mix can be a combination of aggregate 104 with binder 102. Generally, the more the mix has smaller particulate aggregate 104, the greater amount of binder 102 is required for the mix, as the greater amount of smaller particulate results in a greater surface area for the binder 102 to act upon.

The amount of aggregate 104 in the mix can be 90% to 98% (weight percent) aggregate with 2% to 10% (weight percent) binder 102. For example, the mix can include 90% aggregate 104 and 10% binder 102; 91% aggregate 104 and 9% binder 102; 92% aggregate 104 and 8% binder 102; 93% aggregate 104 and 7% binder 102; 94% aggregate 104 and 6% binder 102; 95% aggregate 104 and 5% binder 102; 96% aggregate 104 and 4% binder 102; 97% aggregate 104 and 3% binder 102; 98% aggregate 104 and 2% binder 102. In a preferred embodiment, the mix can be 93% to 96% aggregate 104 and 4% to 7% binder 102. It should be noted that more than 10% binder 102 by weight of aggregate 104 can cause problems for any aggregate 104 of any gradation, as the mix might become “binder rich.” Being binder rich can render the mix unstable. The stability of the mix can be determined by a Hveem stability test.

It should be noted that when the aggregate 104 includes LRA, then the mix can be 97.5% aggregate 104 and 2.5% binder 102. This can be achieved because LRA aggregate 104 already has naturally occurring bituminous material in it, which can reduce the amount of base asphalt 106 (a component of the binder 102) needed for the mix. The bituminous material in LRA can be highly oxidized, which may pose as a problem with conventional mixes. However, embodiments of the binder 102 can include additives 108 (e.g., diesel fuel and maltenes) that counter this by rejuvenating the bituminous material (e.g., these additives 108 can replenish the maltenes lost due to oxidation).

Some embodiments can have a plurality of aggregates 104. For example, the aggregate 104 can have a first aggregate 104a, a second aggregate 104b, etc. The first aggregate 104a can be the same type of aggregate 104 as the second aggregate 104b, but with a different gradation. The first aggregate 104a can be a different type of aggregate 104 as the second aggregate 104b, and have the same or different gradation.

The amount of first aggregate 104a can range from 0% to 100%. The amount of second aggregate 104b can range from 0% to 100%. For example, the aggregate 104 can comprise: 0% first aggregate 104a and 100% second aggregate 104b; 5% first aggregate 104a and 95% second aggregate 104b; 10% first aggregate 104a and 90% second aggregate 104b; 15% first aggregate 104a and 85% second aggregate 104b; 20% first aggregate 104a and 80% second aggregate 104b; 25% first aggregate 104a and 75% second aggregate 104b; 30% first aggregate 104a and 70% second aggregate 104b; 35% first aggregate 104a and 65% second aggregate 104b; 40% first aggregate 104a and 60% second aggregate 104b; 45% first aggregate 104a and 55% second aggregate 104b; 50% first aggregate 104a and 50% second aggregate 104b; 55% first aggregate 104a and 45% second aggregate 104b; 60% first aggregate 104a and 40% second aggregate 104b; 65% first aggregate 104a and 35% second aggregate 104b; 70% first aggregate 104a and 30% second aggregate 104b; 75% first aggregate 104a and 25% second aggregate 104b; 80% first aggregate 104a and 20% second aggregate 104b; 85% first aggregate 104a and 15% second aggregate 104b; 90% first aggregate 104a and 10% second aggregate 104b; 95% first aggregate 104a and 5% second aggregate 104b; 100% first aggregate 104a and 0% second aggregate 104b. More or less aggregates 104 can be used. Any number of aggregates can be used. For example, the asphalt concrete 100 can be made from a first aggregate, a second aggregate, a third aggregate, a fourth aggregate, etc. One skilled in the art, with the benefit of the present disclosure, will appreciate that various combinations and permutations of the percentage of first, second, third, fourth, etc. aggregates can be used.

Base Asphalt

Embodiments of the base asphalt 106 can include bitumen or bituminous material in various types based on a Performance Grade (PG). The PG can be an industry convention that identifies a maximum pavement design temperature and a minimum pavement design pavement temperature. For example, a PG 64-22 can be a base asphalt 106 grade that is designed for a maximum pavement design temperature of 64° C. and a minimum design pavement temperature of −22° C. The base asphalt 106 can be any one or combination of PG 58-10, PG 58-22, PG 58-28, PG 64-10, PG 64-16, PG 64-22, PG 64-28, PG 64-34, PG 70-10, PG 70-16, PG 70-22, PG 70-28, PG 76-22, etc.

The base asphalt 106 can be part of the binder 102 or be used in combination with the binder 102 to form the mix. As noted herein, embodiments of the aggregate 104 (e.g., LRA aggregate 104) can include some bituminous material. In some embodiments, the more bituminous material the aggregate 104 contains, the less binder 102 is needed to make the mix.

### Additive

Embodiments of the additive 108 can include any one or combination of a volatile solvent additive 108a, a base asphalt softener additive 108b, and a hydrocarbon absorber additive 108c. Other additives 108d can be used. These can be chemical admixtures or agents configured to generate certain characteristics, for example. Other additives 108d can include, but are not limited to, emulsion agents, chemical accelerators, chemical retarders, plasticizers, pigments, etc.

The volatile solvent additive 108a can be configured to obtain a desired viscosity for the base asphalt 106. For example, the volatile solvent additive 108a can be configured to keep the base asphalt 106 as a liquid before and/or during the application of the asphalt concrete 100. It is contemplated for the volatile solvent additive 108a to evaporate after application to allow for curing. However, as noted herein, the evaporation of the volatile solvent additive 108a of conventional binders is uncontrolled and occurs while the mix is stockpiled.

With embodiments of the binder 102, the volatile solvent additive 108a evaporates slowly or not at all during stockpiling, but rather evaporates at a desired rate or in a desired amount during application of the mix as asphalt concrete 100 (e.g., being applied as pavement, a sidewalk, roadway, etc.). The volatile solvent additive 108a can include naphtha, kerosene, diesel fuel, gasoline, etc. In at least one embodiment, the volatile solvent additive 108a is diesel fuel.

The base asphalt softener additive 108b can be used to soften the base asphalt 106. The base asphalt softener additive 108b can be maltenes. Embodiments of a maltenes can include aliphatic and aromatic compounds with up to 150 carbon atoms, the compounds being soluble in n-alkane solvent (e.g., pentane, heptane, etc.). The base asphalt softener additive 108b can be a pure form of maltenes and/or a purified form of the maltenes. While diesel fuel can be used in addition to maltenes as the base asphalt softener additive 108b, it is contemplated for maltenes to be used instead of diesel fuel for purposes of the base asphalt softener additive 108b (or at least as much maltenes as is permitted—being permitted can be defined as being within the specifications for the intended use of the asphalt concrete 100).

While diesel fuel (being used as the base asphalt softener additive 108b) can soften the base asphalt 106 with greater efficiency (e.g., less amount or concentration of the additive 108 is needed to achieve the desired amount of softening) as the maltenes, diesel fuel tends to evaporate from the mix, whereas maltenes do not. Thus, use of maltenes as the base asphalt softener additive 108b and use of diesel fuel as the volatile solvent additive 108a can be beneficial in that the diesel fuel will evaporate at a controlled rate or at a predetermined time for curing purposes, while the maltenes stay within the mix to keep the base asphalt soft and workable.

In at least one embodiment, the addition of the base asphalt softener additive 108b can be made to generate a High Yield Asphalt binder (“HYA”) for the asphalt concrete 100. The HYA can be configured to reduce the amount or concentration of asphalt binder needed to achieve a predetermined Unconfined Compressive Strength (UCS) that allows the asphalt concrete 100 to be used for a desired application (e.g., as pavement, a sidewalk, a roadway, etc.). UCS can be defined as the ratio of failure load to the cross sectional area of a sample being tested. UCS can be measured in pounds per square inch (“psi”).

The amount of base asphalt softener additive 108b that can be added can include a wide range of weight percents. The amount of base asphalt softener additive 108b added depends upon to composition of the aggregate 104, the amount and composition of base asphalt 106 used, and the material properties desired for the asphalt concrete 100. Thus, monitoring and testing can be performed to the aggregate 104 and/or the mix as the base asphalt softener additive 108b is added to determine the amount and type of base asphalt softener additive 108b needed to generate the desired material properties for the asphalt concrete 100.

The hydrocarbon absorber additive 108c can be configured to absorb at least some volatile hydrocarbon fractions. This can include chemical absorption. For example, embodiments of the hydrocarbon absorber additive 108c can be a heavy carbon fraction so as to absorb light carbon fractions. The hydrocarbon absorber additive 108c can be asphaltene. Embodiments of the asphaltene can include aliphatic and aromatic compounds with up to 150 carbon atoms, the compounds being insoluble in n-alkane solvent (e.g., pentane, heptane, etc.). The hydrocarbon absorber additive 108c can be a pure form of asphaltene or a purified form of asphaltene. An example of an asphaltene can be gilsonite. The absorption of at least some volatile hydrocarbon fractions can make the binder 102 more cohesive to rock. The absorption can also involve absorbing at least some of the volatile solvent additive 108a to be released at a controlled rate or at a predetermined time for curing purposes.

Use of the hydrocarbon absorber additive 108c can prevent the volatile solvent additive 108a from evaporating too quickly (e.g., evaporating during stockpiling), thereby enhance or refined material properties (e.g., viscosity, stability, compressive strength, mix specification tolerances, etc.) and/or improved handling properties (e.g., greater stockpile life, more cost effective, etc.) of the asphalt concrete 100. For example, with embodiments of the binder 102 disclosed herein, the mix can be used immediately, stockpiled for 1 day, 1 week, 1 month, 2 months, 3 months, 4 months, 5 months, 6 months, 7 months, 8 months, 9 months, 10 months, 11 months, 12 months, or within any time period there-between without the mix being unworkable, incurable, and unhardenable during application of the mix as asphalt concrete 100.

The absorption of volatile hydrocarbon fractions can also enhance the stability of the asphalt concrete 100. For example, the existence of high levels of volatile hydrocarbon fractions in the asphalt concrete 100 can lower its stability (e.g., can result in a soft, non-structurally sound asphalt concrete 100). Yet, embodiments of the binder 102 having the hydrocarbon absorber additive 108c can absorb at least some of the volatile hydrocarbon fractions so as to facilitate generating a stabilized asphalt concrete 100.

The amount of hydrocarbon absorber additive 108c that can be added can include a wide range of weight percents. The amount of hydrocarbon absorber additive 108c added depends upon to composition of the aggregate 104, the amount and composition of the volatile hydrocarbon fractions present, and the material properties desired for the asphalt concrete 100. Thus, monitoring and testing can be performed to the aggregate 104 and/or mix as the hydrocarbon absorber additive 108c is added to determine the amount and type of a hydrocarbon absorber additive 108c needed to generate the desired material properties for the asphalt concrete 100.

The amount of additive 108 can range from 0% to 100%. For example, the amount of additive 108 added can be 0%, 5%, 10%, 15%, 20%, 25%, 30%, 35%, 40%, 45%, 50%, 55%, 60%, 65%, 70%, 75%, 80%, 85%, 90%, 95%, 100%, or any percent within 0% to 100%. The additive 108 can include a volatile solvent additive 108a, a base asphalt softener additive 108b, and/or a hydrocarbon absorber additive 108c. The amount of volatile solvent additive 108a can range from 0% to 100%. The amount of base asphalt softener additive 108b can range from 0% to 100%. The amount of hydrocarbon absorber additive 108c can range from 0% to 100%. For example, the additive 108 can comprise: 100% volatile solvent additive 108a, 0% base asphalt softener additive 108b, 0% hydrocarbon absorber additive 108c; 95% volatile solvent additive 108a, 5% base asphalt softener additive 108b, 0% hydrocarbon absorber additive 108c; 90% volatile solvent additive 108a, 10% base asphalt softener additive 108b, 0% hydrocarbon absorber additive 108c; 85% volatile solvent additive 108a, 15% base asphalt softener additive 108b, 0% hydrocarbon absorber additive 108c; 80% volatile solvent additive 108a, 20% base asphalt softener additive 108b, 0% hydrocarbon absorber additive 108c; 75% volatile solvent additive 108a, 25% base asphalt softener additive 108b, 0% hydrocarbon absorber additive 108c; 70% volatile solvent additive 108a, 30% base asphalt softener additive 108b, 0% hydrocarbon absorber additive 108c; 65% volatile solvent additive 108a, 35% base asphalt softener additive 108b, 0% hydrocarbon absorber additive 108c; 60% volatile solvent additive 108a, 40% base asphalt softener additive 108b, 0% hydrocarbon absorber additive 108c; 55% volatile solvent additive 108a, 45% base asphalt softener additive 108b, 0% hydrocarbon absorber additive 108c; 50% volatile solvent additive 108a, 50% base asphalt softener additive 108b, 0% hydrocarbon absorber additive 108c; 45% volatile solvent additive 108a, 55% base asphalt softener additive 108b, 0% hydrocarbon absorber additive 108c; 40% volatile solvent additive 108a, 60% base asphalt softener additive 108b, 0% hydrocarbon absorber additive 108c; 35% volatile solvent additive 108a, 65% base asphalt softener additive 108b, 0% hydrocarbon absorber additive 108c; 30% volatile solvent additive 108a, 70% base asphalt softener additive 108b, 0% hydrocarbon absorber additive 108c; 25% volatile solvent additive 108a, 75% base asphalt softener additive 108b, 0% hydrocarbon absorber additive 108c; 20% volatile solvent additive 108a, 80% base asphalt softener additive 108b, 0% hydrocarbon absorber additive 108c; 15% volatile solvent additive 108a, 85% base asphalt softener additive 108b, 0% hydrocarbon absorber additive 108c; 10% volatile solvent additive 108a, 90% base asphalt softener additive 108b, 0% hydrocarbon absorber additive 108c; 5% volatile solvent additive 108a, 95% base asphalt softener additive 108b, 0% hydrocarbon absorber additive 108c; 0% volatile solvent additive 108a, 100% base asphalt softener additive 108b, 0% hydrocarbon absorber additive 108c; 95% volatile solvent additive 108a, 0% base asphalt softener additive 108b, 5% hydrocarbon absorber additive 108c; 90% volatile solvent additive 108a, 0% base asphalt softener additive 108b, 10% hydrocarbon absorber additive 108c; 85% volatile solvent additive 108a, 0% base asphalt softener additive 108b, 15% hydrocarbon absorber additive 108c; 80% volatile solvent additive 108a, 0% base asphalt softener additive 108b, 20% hydrocarbon absorber additive 108c; 75% volatile solvent additive 108a, 0% base asphalt softener additive 108b, 25% hydrocarbon absorber additive 108c; 70% volatile solvent additive 108a, 0% base asphalt softener additive 108b, 30% hydrocarbon absorber additive 108c; 65% volatile solvent additive 108a, 0% base asphalt softener additive 108b, 35% hydrocarbon absorber additive 108c; 60% volatile solvent additive 108a, 0% base asphalt softener additive 108b, 40% hydrocarbon absorber additive 108c; 55% volatile solvent additive 108a, 0% base asphalt softener additive 108b, 45% hydrocarbon absorber additive 108c; 50% volatile solvent additive 108a, 0% base asphalt softener additive 108b, 50% hydrocarbon absorber additive 108c; 45% volatile solvent additive 108a, 0% base asphalt softener additive 108b, 55% hydrocarbon absorber additive 108c; 40% volatile solvent additive 108a, 0% base asphalt softener additive 108b, 60% hydrocarbon absorber additive 108c; 35% volatile solvent additive 108a, 0% base asphalt softener additive 108b, 65% hydrocarbon absorber additive 108c; 30% volatile solvent additive 108a, 0% base asphalt softener additive 108b, 70% hydrocarbon absorber additive 108c; 25% volatile solvent additive 108a, 0% base asphalt softener additive 108b, 75% hydrocarbon absorber additive 108c; 20% volatile solvent additive 108a, 0% base asphalt softener additive 108b, 80% hydrocarbon absorber additive 108c; 15% volatile solvent additive 108a, 0% base asphalt softener additive 108b, 85% hydrocarbon absorber additive 108c; 10% volatile solvent additive 108a, 0% base asphalt softener additive 108b, 90% hydrocarbon absorber additive 108c; 5% volatile solvent additive 108a, 0% base asphalt softener additive 108b, 95% hydrocarbon absorber additive 108c; 0% volatile solvent additive 108a, 0% base asphalt softener additive 108b, 100% hydrocarbon absorber additive 108c; 0% volatile solvent additive 108a, 100% base asphalt softener additive 108b, 0% hydrocarbon absorber additive 108c; 5% volatile solvent additive 108a, 95% base asphalt softener additive 108b, 0% hydrocarbon absorber additive 108c; 10% volatile solvent additive 108a, 90% base asphalt softener additive 108b, 0% hydrocarbon absorber additive 108c; 15% volatile solvent additive 108a, 85% base asphalt softener additive 108b, 0% hydrocarbon absorber additive 108c; 20% volatile solvent additive 108a, 80% base asphalt softener additive 108b, 0% hydrocarbon absorber additive 108c; 25% volatile solvent additive 108a, 75% base asphalt softener additive 108b, 0% hydrocarbon absorber additive 108c; 30% volatile solvent additive 108a, 70% base asphalt softener additive 108b, 0% hydrocarbon absorber additive 108c; 35% volatile solvent additive 108a, 65% base asphalt softener additive 108b, 0% hydrocarbon absorber additive 108c; 40% volatile solvent additive 108a, 60% base asphalt softener additive 108b, 0% hydrocarbon absorber additive 108c; 45% volatile solvent additive 108a, 55% base asphalt softener additive 108b, 0% hydrocarbon absorber additive 108c; 50% volatile solvent additive 108a, 50% base asphalt softener additive 108b, 0% hydrocarbon absorber additive 108c; 55% volatile solvent additive 108a, 45% base asphalt softener additive 108b, 0% hydrocarbon absorber additive 108c; 60% volatile solvent additive 108a, 40% base asphalt softener additive 108b, 0% hydrocarbon absorber additive 108c; 65% volatile solvent additive 108a, 35% base asphalt softener additive 108b, 0% hydrocarbon absorber additive 108c; 70% volatile solvent additive 108a, 30% base asphalt softener additive 108b, 0% hydrocarbon absorber additive 108c; 75% volatile solvent additive 108a, 25% base asphalt softener additive 108b, 0% hydrocarbon absorber additive 108c; 80% volatile solvent additive 108a, 20% base asphalt softener additive 108b, 0% hydrocarbon absorber additive 108c; 85% volatile solvent additive 108a, 15% base asphalt softener additive 108b, 0% hydrocarbon absorber additive 108c; 90% volatile solvent additive 108a, 10% base asphalt softener additive 108b, 0% hydrocarbon absorber additive 108c; 95% volatile solvent additive 108a, 5% base asphalt softener additive 108b, 0% hydrocarbon absorber additive 108c; 100% volatile solvent additive 108a, 0% base asphalt softener additive 108b, 0% hydrocarbon absorber additive 108c; 0% volatile solvent additive 108a, 95% base asphalt softener additive 108b, 5% hydrocarbon absorber additive 108c; 0% volatile solvent additive 108a, 90% base asphalt softener additive 108b, 10% hydrocarbon absorber additive 108c; 0% volatile solvent additive 108a, 85% base asphalt softener additive 108b, 15% hydrocarbon absorber additive 108c; 0% volatile solvent additive 108a, 80% base asphalt softener additive 108b, 20% hydrocarbon absorber additive 108c; 0% volatile solvent additive 108a, 75% base asphalt softener additive 108b, 25% hydrocarbon absorber additive 108c; 0% volatile solvent additive 108a, 70% base asphalt softener additive 108b, 30% hydrocarbon absorber additive 108c; 0% volatile solvent additive 108a, 65% base asphalt softener additive 108b, 35% hydrocarbon absorber additive 108c; 0% volatile solvent additive 108a, 60% base asphalt softener additive 108b, 40% hydrocarbon absorber additive 108c; 0% volatile solvent additive 108a, 55% base asphalt softener additive 108b, 45% hydrocarbon absorber additive 108c; 0% volatile solvent additive 108a, 50% base asphalt softener additive 108b, 50% hydrocarbon absorber additive 108c; 0% volatile solvent additive 108a, 45% base asphalt softener additive 108b, 55% hydrocarbon absorber additive 108c; 0% volatile solvent additive 108a, 40% base asphalt softener additive 108b, 60% hydrocarbon absorber additive 108c; 0% volatile solvent additive 108a, 35% base asphalt softener additive 108b, 65% hydrocarbon absorber additive 108c; 0% volatile solvent additive 108a, 30% base asphalt softener additive 108b, 70% hydrocarbon absorber additive 108c; 0% volatile solvent additive 108a, 25% base asphalt softener additive 108b, 75% hydrocarbon absorber additive 108c; 0% volatile solvent additive 108a, 20% base asphalt softener additive 108b, 80% hydrocarbon absorber additive 108c; 0% volatile solvent additive 108a, 15% base asphalt softener additive 108b, 85% hydrocarbon absorber additive 108c; 0% volatile solvent additive 108a, 10% base asphalt softener additive 108b, 90% hydrocarbon absorber additive 108c; 0% volatile solvent additive 108a, 5% base asphalt softener additive 108b, 95% hydrocarbon absorber additive 108c; 0% volatile solvent additive 108a, 0% base asphalt softener additive 108b, 100% hydrocarbon absorber additive 108c; 0% volatile solvent additive 108a, 0% base asphalt softener additive 108b, 100% hydrocarbon absorber additive 108c; 5% volatile solvent additive 108a, 0% base asphalt softener additive 108b, 95% hydrocarbon absorber additive 108c; 10% volatile solvent additive 108a, 0% base asphalt softener additive 108b, 90% hydrocarbon absorber additive 108c; 15% volatile solvent additive 108a, 0% base asphalt softener additive 108b, 85% hydrocarbon absorber additive 108c; 20% volatile solvent additive 108a, 0% base asphalt softener additive 108b, 80% hydrocarbon absorber additive 108c; 25% volatile solvent additive 108a, 0% base asphalt softener additive 108b, 75% hydrocarbon absorber additive 108c; 30% volatile solvent additive 108a, 0% base asphalt softener additive 108b, 70% hydrocarbon absorber additive 108c; 35% volatile solvent additive 108a, 0% base asphalt softener additive 108b, 65% hydrocarbon absorber additive 108c; 40% volatile solvent additive 108a, 0% base asphalt softener additive 108b, 60% hydrocarbon absorber additive 108c; 45% volatile solvent additive 108a, 0% base asphalt softener additive 108b, 55% hydrocarbon absorber additive 108c; 50% volatile solvent additive 108a, 0% base asphalt softener additive 108b, 50% hydrocarbon absorber additive 108c; 55% volatile solvent additive 108a, 0% base asphalt softener additive 108b, 45% hydrocarbon absorber additive 108c; 60% volatile solvent additive 108a, 0% base asphalt softener additive 108b, 40% hydrocarbon absorber additive 108c; 65% volatile solvent additive 108a, 0% base asphalt softener additive 108b, 35% hydrocarbon absorber additive 108c; 70% volatile solvent additive 108a, 0% base asphalt softener additive 108b, 30% hydrocarbon absorber additive 108c; 75% volatile solvent additive 108a, 0% base asphalt softener additive 108b, 25% hydrocarbon absorber additive 108c; 80% volatile solvent additive 108a, 0% base asphalt softener additive 108b, 20% hydrocarbon absorber additive 108c; 85% volatile solvent additive 108a, 0% base asphalt softener additive 108b, 15% hydrocarbon absorber additive 108c; 90% volatile solvent additive 108a, 0% base asphalt softener additive 108b, 10% hydrocarbon absorber additive 108c; 95% volatile solvent additive 108a, 0% base asphalt softener additive 108b, 5% hydrocarbon absorber additive 108c; 100% volatile solvent additive 108a, 0% base asphalt softener additive 108b, 0% hydrocarbon absorber additive 108c; 0% volatile solvent additive 108a, 5% base asphalt softener additive 108b, 95% hydrocarbon absorber additive 108c; 0% volatile solvent additive 108a, 10% base asphalt softener additive 108b, 90% hydrocarbon absorber additive 108c; 0% volatile solvent additive 108a, 15% base asphalt softener additive 108b, 85% hydrocarbon absorber additive 108c; 0% volatile solvent additive 108a, 20% base asphalt softener additive 108b, 80% hydrocarbon absorber additive 108c; 0% volatile solvent additive 108a, 25% base asphalt softener additive 108b, 75% hydrocarbon absorber additive 108c; 0% volatile solvent additive 108a, 30% base asphalt softener additive 108b, 70% hydrocarbon absorber additive 108c; 0% volatile solvent additive 108a, 35% base asphalt softener additive 108b, 65% hydrocarbon absorber additive 108c; 0% volatile solvent additive 108a, 40% base asphalt softener additive 108b, 60% hydrocarbon absorber additive 108c; 0% volatile solvent additive 108a, 45% base asphalt softener additive 108b, 55% hydrocarbon absorber additive 108c; 0% volatile solvent additive 108a, 50% base asphalt softener additive 108b, 50% hydrocarbon absorber additive 108c; 0% volatile solvent additive 108a, 55% base asphalt softener additive 108b, 45% hydrocarbon absorber additive 108c; 0% volatile solvent additive 108a, 60% base asphalt softener additive 108b, 40% hydrocarbon absorber additive 108c; 0% volatile solvent additive 108a, 65% base asphalt softener additive 108b, 35% hydrocarbon absorber additive 108c; 0% volatile solvent additive 108a, 70% base asphalt softener additive 108b, 30% hydrocarbon absorber additive 108c; 0% volatile solvent additive 108a, 75% base asphalt softener additive 108b, 25% hydrocarbon absorber additive 108c; 0% volatile solvent additive 108a, 80% base asphalt softener additive 108b, 20% hydrocarbon absorber additive 108c; 0% volatile solvent additive 108a, 85% base asphalt softener additive 108b, 15% hydrocarbon absorber additive 108c; 0% volatile solvent additive 108a, 90% base asphalt softener additive 108b, 10% hydrocarbon absorber additive 108c; 0% volatile solvent additive 108a, 95% base asphalt softener additive 108b, 5% hydrocarbon absorber additive 108c; 0% volatile solvent additive 108a, 100% base asphalt softener additive 108b, 0% hydrocarbon absorber additive 108c.

The binder 102 formulation (e.g., the amounts and types of base asphalt 106 and additive 108) depends on several variables. Generally, the softer the base asphalt 106, the less the amount of additives 108 can be used for the binder 102. The amount of additive 108 to add to base asphalt 106 can be determined by a measure of the kinematic viscosity. When the kinematic viscosity of the binder 102 is within a range from 250 cSt to 1500 cSt @140 deg. F. (e.g., approximately 750 cSt), then a sufficient amount of additive 108 is present.

### EXAMPLES

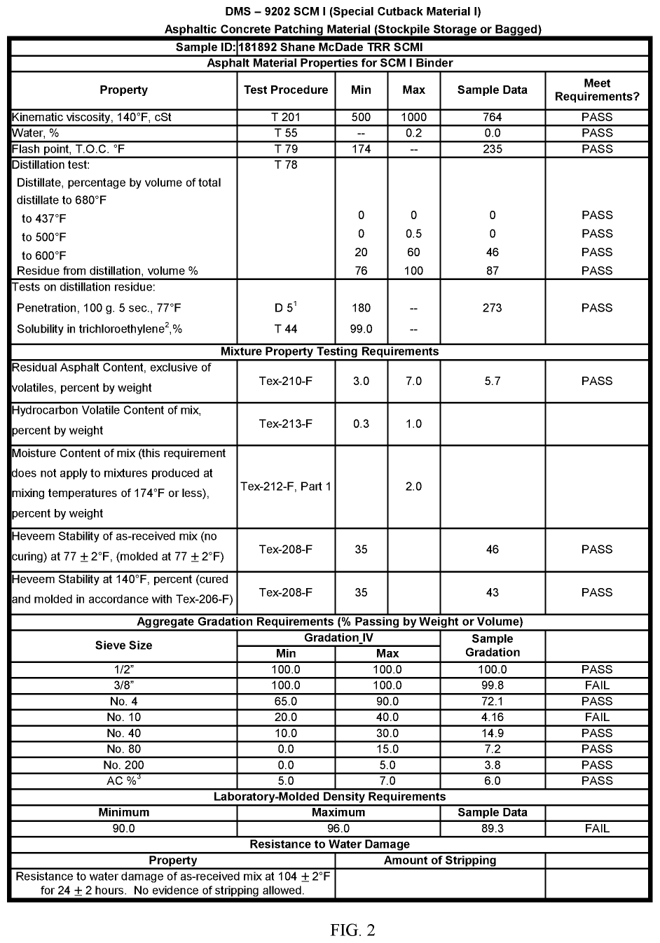

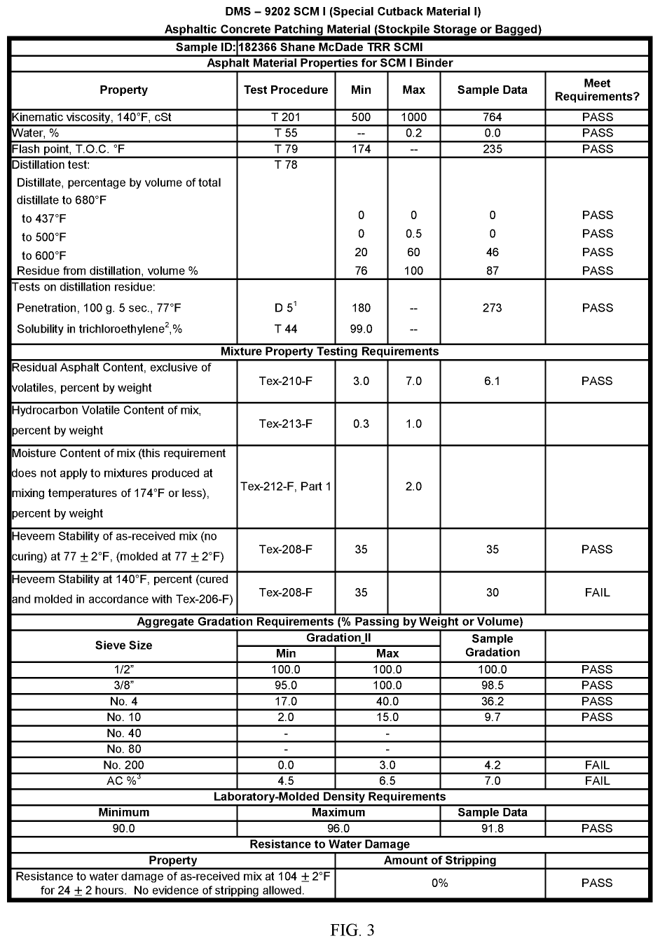

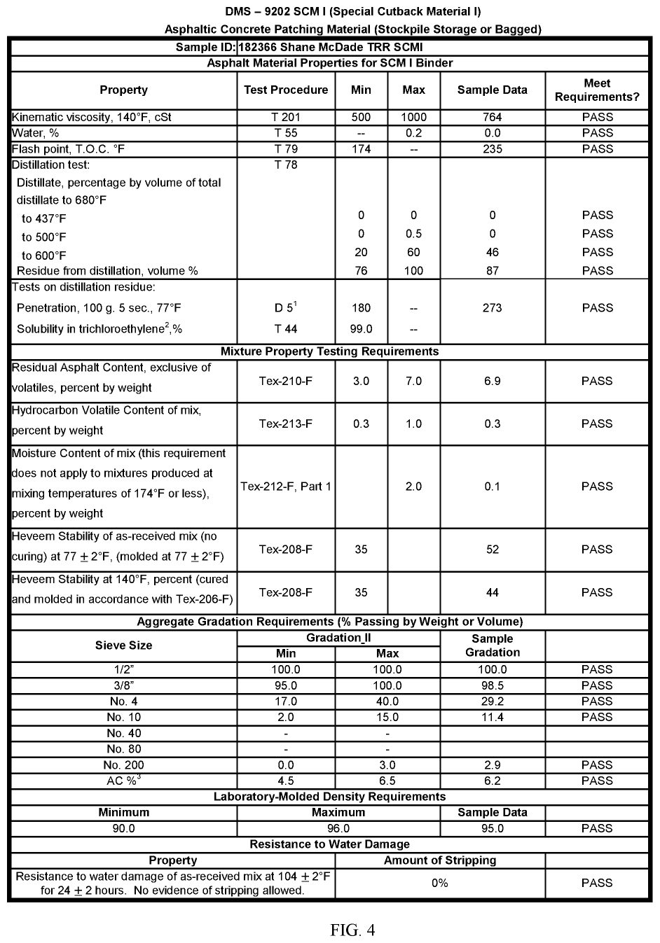

Referring to FIGS. 2-4, an exemplary mix includes 97.5% LRA aggregate and 2.5% binder. The binder 102 includes 70% 64-22 base asphalt 106, 22% diesel fuel as the volatile solvent additive 108a, 7% maltenes as the base asphalt softener additive 108b, and 1% gilsonite as the hydrocarbon absorber additive 108c. Using the exemplary binder 102 formulation to generate the mix, the material specifications outlined in the laboratory reports of FIGS. 2-4 were met. It should be noted that any of the additives 108 can vary within 20% and still meet the material specifications outlined in FIGS. 2-4. Thus, the exemplary binder 102 can include 17.6%-26.4% diesel fuel as the volatile solvent additive 108a, 5.6%-8.4% maltenes as the base asphalt softener additive 108b, and 0.8%-1.2% gilsonite as the hydrocarbon absorber additive 108c.

It should be understood that modifications to the embodiments disclosed herein can be made to meet a particular set of design criteria. For instance, the number of or configuration of aggregates 104, binders 102, additives 108, and/or other components or parameters may be used to meet a particular objective. In addition, any of the embodiments of the asphalt concrete 100 and/or binder 102 disclosed herein can be used with other embodiments of the asphalt concrete 100 and/or binder 102.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

Therefore, it is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of apparatuses and methods of making and using the same have been discussed and illustrated herein, it is to be distinctly understood that the invention is not limited thereto but may be otherwise variously embodied and practiced within the scope of the following claims.

It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement. Thus, while certain exemplary embodiments of the asphalt concrete 100 and/or binder 102 have been shown and described above, it is to be distinctly understood that the invention is not limited thereto but may be otherwise variously embodied and practiced within the scope of the following claims.

What is claimed is:

1. A binder additive, comprising:
a volatile solvent additive comprising diesel fuel;
a base asphalt softener additive comprising maltenes; and
a hydrocarbon absorber additive comprising gilsonite, the hydrocarbon absorber additive being configured to absorb at least some volatile hydrocarbon fractions of the volatile solvent additive.

2. The binder additive recited in claim 1, wherein the binder additive is an asphaltic binder additive configured to be combined with base asphalt.

3. The binder additive recited in claim 2, wherein the binder additive is configured to obtain a desired viscosity for the base asphalt/binder additive mixture.

4. The binder additive recited in claim 1, wherein the binder additive comprises any one or combination of naphtha, kerosene, diesel fuel, and gasoline.

5. The binder additive recited in claim 2, wherein the base asphalt softener additive is configured to soften the base asphalt.

6. An asphalt concrete, comprising:
aggregate; and
a binder additive comprising base asphalt and at least one additive, the at least one additive configured to volatile hydrocarbon fractions and controllably release the volatile hydrocarbon fractions.

7. The asphalt concrete recited in claim 6, wherein the binder additive comprises:
a volatile solvent additive comprising diesel fuel;
a base asphalt softener additive comprising maltenes; and
a hydrocarbon absorber additive comprising gilsonite, the hydrocarbon absorber additive being configured to absorb at least some volatile hydrocarbon fractions of the volatile solvent additive.

8. The asphalt concrete recited in claim 7, wherein the aggregate comprises a first aggregate and a second aggregate.

9. The asphalt concrete recited in claim 7, wherein the binder additive is configured to obtain a desired viscosity for a mixture comprising base asphalt and the binder additive.

10. The asphalt concrete recited in claim 7, wherein the binder additive comprises any one or combination of naphtha, kerosene, diesel fuel, and gasoline.

11. The asphalt concrete recited in claim 7, wherein the base asphalt softener additive is configured to soften the base asphalt.

13. The asphalt concrete recited in claim 7, further comprising additional maltenes additive to generate a high yield asphalt cement.

14. The asphalt concrete recited in claim 7, wherein the aggregate comprises any one or combination of sand, gravel, crushed stone, slag, recycled roadway material, limestone, granite, shale, caliche, and Limestone Rock Aggregate (LRA).

15. The asphalt concrete recited in claim 7, wherein the asphalt concrete is workable, curable, and able to be hardened after being stockpiled for six months.

16. The asphalt concrete recited in claim 7, wherein the asphalt concrete is workable, curable, and able to be hardened after being stockpiled for one year.

17. A method for preparing and using asphalt concrete, the method comprising:
adding a binder to an aggregate to form a mix;
allowing the mix to be stockpiled for a time period within a range from one hour to one year;
within a temperature range from 20° F. and 120° F., compacting the mix into an asphalt concrete formation; and
allowing the asphalt concrete formation to cure and harden.

18. The method recited in claim 17, further comprising generating the binder by combining a binder additive containing diesel fuel, a base asphalt softener additive containing maltenes, and a hydrocarbon absorber additive containing gilsonite, the hydrocarbon absorber additive being configured to absorb at least some volatile hydrocarbon fractions of the volatile solvent additive.

19. The method recited in claim 17, further comprising adding a maltenes additive to generate a high yield asphalt cement.

20. An asphalt concrete, comprising a combination of Limestone Rock Aggregate (LRA) and a binder to form a cold patch concrete.

21. The asphalt concrete recited in claim 20, wherein the binder comprises diesel fuel.

22. The asphalt concrete recited in claim 20, wherein a weight percent of LRA is within a range from 99% to 95%.
